(19) United States
(12) Patent Application Publication
(10) Pub. No.: US 2019/0251215 A1
(43) Pub. Date: Aug. 15, 2019

(54) ACCURATE ESTIMATION OF UPPER ATMOSPHERIC DENSITY USING SATELLITE OBSERVATIONS

(71) Applicant: Regents of the University of Minnesota, Minneapolis, MN (US)

(72) Inventors: Richard Linares, Cambridge, MA (US); Piyush M. Mehta, Morgantown, WV (US)

(21) Appl. No.: 16/266,515

(22) Filed: Feb. 4, 2019

Related U.S. Application Data
(60) Provisional application No. 62/631,231, filed on Feb. 15, 2018.

(51) Int. Cl. G06F 17/50; G01W 1/10; B64G 3/00; B64G 1/10

(52) U.S. Cl. CPC G06F 17/5009; G01W 1/10; B64G 3/00; H03H 17/0202; G06F 2217/16; G06F 2217/06; B64G 2001/1042; B64G 1/1021

(57) ABSTRACT

This disclosure describes techniques for providing a transformative framework to forecast physical properties of an atmosphere to predict the orbit of satellite devices. As one example, the transformative framework has two major components: (i) the development of a quasi-physical dynamic reduced-order model (ROM) that uses a linear approximation of the underlying dynamics (e.g., solar conditions or magnetic conditions) and effect of the drivers, and (ii) data assimilation and calibration of the ROM through estimation of the ROM coefficients that represent the model parameters.

This application claims the benefit of U.S. Provisional Patent Application No. 62/631,231 filed Feb. 15, 2018, the entire content being incorporated herein by reference.

### TECHNICAL FIELD

The invention relates to satellite devices and the like.

### BACKGROUND

Satellite devices orbit the Earth or other celestial bodies and provide a variety of functions, such as communication, observation data (e.g., weather, space images, etc.), and/or navigation data. A satellite device's orbit trajectory may be affected by variations in physical properties of the celestial body's atmosphere. For example, satellite devices may encounter orbital drag due to variations in the Earth's atmosphere, e.g., ionosphere-thermosphere, caused from irradiance of a Sun, solar rotation and cycle, diurnal and higher-order harmonics, magnetic storms and substorms, gravity waves, winds and tides, long-term climate change, and other factors.

Satellite owners and/or operators face the complex challenge of calculating and maintaining satellite orbits, which may require accurately forecasting physical properties of the atmosphere. Accurately forecasting a physical property of the atmosphere, for example, is used for in-orbit collision prediction and avoidance. Satellite control devices typically use physics-based models or empirical models to forecast a physical property of the atmosphere. However, conventional models to forecast the physical properties of the atmosphere are highly complex, and the errors associated with the models make necessary continuous assimilation of observations, which can be very inefficient and computationally intensive.

### SUMMARY

In general, this disclosure describes techniques for providing a transformative framework to forecast physical properties of an atmosphere to predict the orbit of satellite devices. As one example, the transformative framework has two major components: (i) the development of a quasi-physical dynamic reduced-order model (ROM) that uses a linear approximation of the underlying dynamics (e.g., solar conditions or magnetic conditions) and effect of the drivers, and (ii) data assimilation and calibration of the ROM through estimation of the ROM coefficients that represent the model parameters. The quasi-physical dynamic ROM is developed using, for example, a physical model, such as a large dataset of simulations (e.g., Thermosphere-Ionosphere-Electrodynamics General Circulation Model (TIE-GCM)) of an atmosphere. The quasi-physical dynamic ROM is based on dynamic mode decomposition with control (DMDc) and uses a Hermitian space to derive a dynamic and input matrices in a tractable manner. The quasi-physical dynamic ROM may also be referred to herein as Hermitian space-dynamic mode decomposition with control (HS-DMDc).

In some examples, a Kalman filter is used to calibrate the quasi-physical dynamic ROM through data assimilation. The Kalman filter provides state estimation and prediction. That is, the Kalman filter is used to estimate a reduced state that represents the quasi-physical dynamic ROM parameters rather than the input(s)/driver(s).

In essence, the transformative framework provides for estimating and calibrating the state of the atmosphere using the quasi-physical dynamic ROM with data assimilation. The transformative framework combines empirical models (i.e., models that are low-cost) and physical models (i.e., models that have predictive capabilities) and facilitates accurate uncertainty quantification with the atmosphere simulations.

The transformative framework provides real-time operational updates to the state of the atmosphere in the context of drag modeling for space situational awareness and space traffic management. The transformative framework requires less complex modeling and data assimilation for physics-based model of the atmosphere for estimating atmospheric density, for example. This may be used for accurate computation of orbital drag, collision conjunctions, and collision avoidance for satellites, as examples.

The techniques may provide one or more technical advantages. For example, the quasi-physical dynamic ROM reduces the cost of model evaluation to the level of empirical models while inherently providing forecast/predictive capabilities. Unlike large-scale physical models, the quasi-physical dynamic ROM formulation allows rapid modifications in the time step of model evaluation or simulation with a negligible increase in the computational cost. This allows the model to be easily projected to the time of next measurement. The quasi-physical dynamic ROM formulation also allows large ensemble runs of the models for improved characterization and quantification of forecast uncertainty, a crucial requirement for accurate computation of collision probabilities.

Moreover, because the data assimilation of the transformative framework may estimate a reduced state that represents model parameters, the data assimilation may dynamically bring the model to agreement with measurements without modifying the model dynamics. Further, by estimating model parameters rather than the input(s)/driver(s), the model is able to be calibrated to prevent degradation of model performance in the absence of measurement data.

The transformative framework requires minimal computational resources. That is, by using the transformative framework, the satellite orbit is accurately computed while using less fuel consumption and reducing costs. Moreover, the transformative framework can be readily incorporated into operations, and can be incorporated into the satellite devices or remotely within a ground-based control station that controls the satellite devices.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram illustrating an environment for providing a transformative framework to forecast physical properties of an atmosphere, in accordance with the techniques described in this disclosure.

FIG. 2 shows a detailed example of a satellite device that may be configured to implement the techniques of the disclosure.

FIG. 3 illustrates an example of the effectiveness of the data assimilation process through the transformative framework, in accordance with the techniques described herein.

FIG. 4 illustrates an example of the validation of the assimilation process using an independent set of simulated measurements (MSIS) along the satellite orbit (e.g., GOCE orbit), in accordance with the techniques described herein.

FIG. 5 illustrates an example of assimilation results for the filter initialized with MSIS, in accordance with the techniques described herein.

FIG. 6 illustrates an example of the estimated reduced-order state and uncertainty with data assimilation, in accordance with the techniques described herein.

FIG. 7 illustrates an example of the validation of the data assimilation using an independent data set of satellite (e.g., GOCE) accelerometer-derived mass density, in accordance with the techniques described herein.

FIGS. 8 and 9 illustrate examples of the global estimated covariance as a projection away from the location of measurements, in accordance with the techniques described herein.

FIG. 10 shows the comparison of MSIS and TIE-GCM profiles against the ROM assimilated profiles at a series of altitudes, in accordance with the techniques described herein.

FIG. 11 illustrates a flowchart of an example operation of a computing device providing a transformative framework, in accordance with the techniques described in this disclosure.

### DETAILED DESCRIPTION

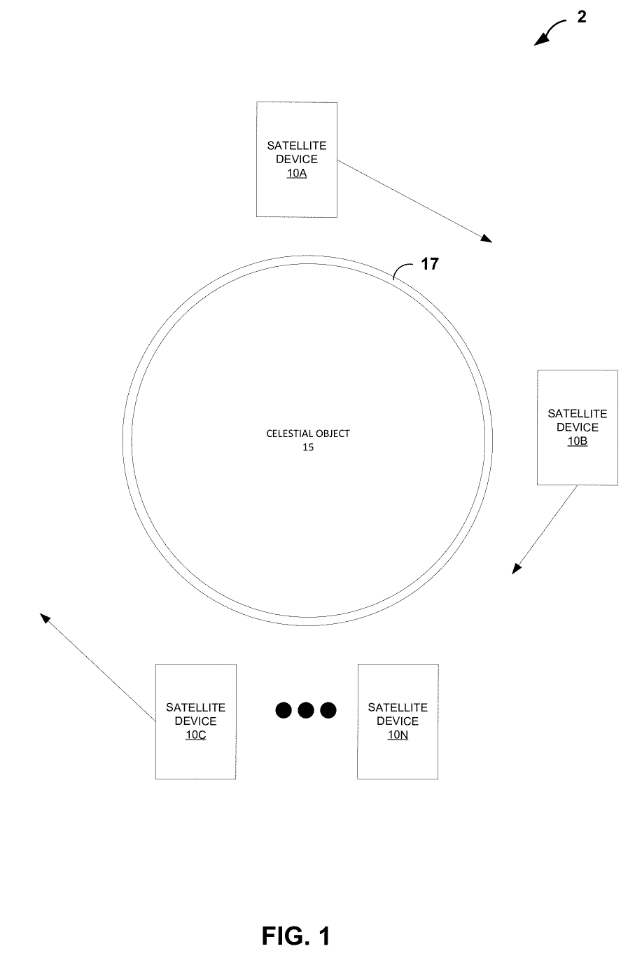

FIG. 1 is a block diagram illustrating an environment 2 for providing a transformative framework to forecast physical properties of an atmosphere to predict the orbit of satellite devices, in accordance with the techniques described in this disclosure. Environment 2 may include one or more satellite devices 10A-10N (collectively, “satellite devices 10”) using a transformative framework for forecasting the state of the atmosphere 17 of celestial object 15, in accordance with the techniques described in this disclosure.

Environment 2 may, for example, represent any environment in which one or more satellite devices 10 may orbit around celestial object 15. Satellite devices 10 orbiting around celestial object 15 may provide communications relaying, observation of celestial object 15 (or other objects in environment 2), and/or navigation within celestial object 15. Celestial object 15 may include a planet, moon, or other celestial object in which satellite devices 10 may orbit around. Although illustrated with a single celestial object 15, environment 2 may include any number of celestial objects for which satellite devices 10 may orbit around.

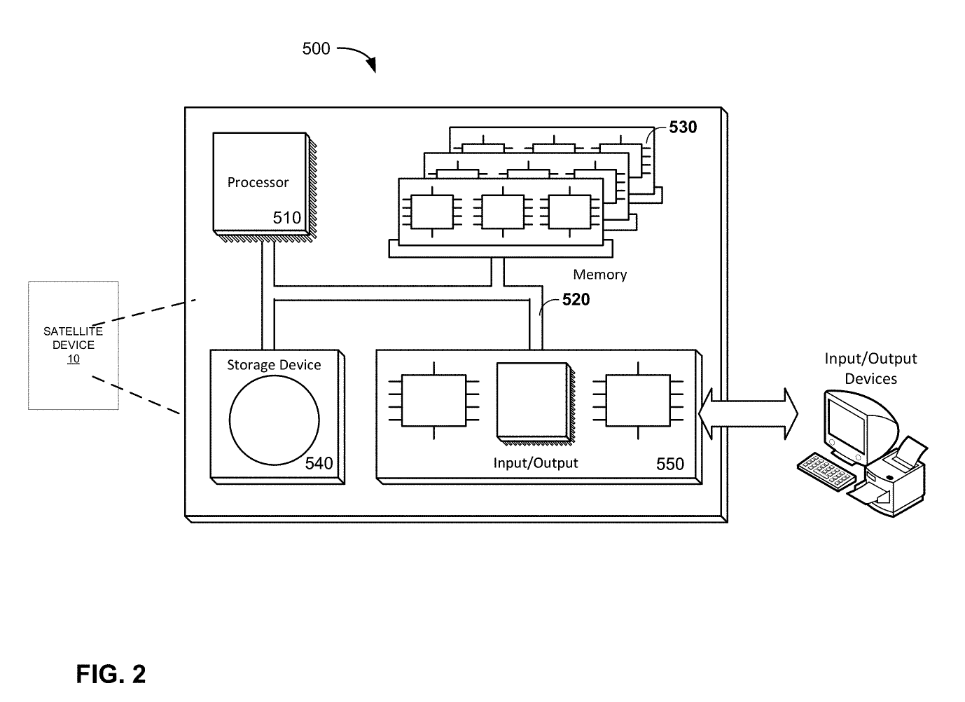

Satellite devices 10 may each represent any device that implements the techniques described herein. Satellite devices 10 may be, for example, communication satellites, observation satellites, navigation satellites, weather satellites, space stations, spacecrafts, space telescopes, or any other device for orbiting around celestial object 15. For purposes of examples, satellite devices 10 are each shown as an observation satellite, although satellite devices 10 may take the form of other devices that implement the techniques described herein. As further described in FIG. 2, the techniques described herein may be applied by a computing platform, such as one or more processors, within a satellite control computing device, which may be located within one or more of satellite devices 10 or positioned remotely, such as within a ground-based control station that controls the satellite devices 10.

In some examples in which celestial body 15 is the Earth, satellite devices 10 may orbit around the Earth in a low Earth orbit (LEO). An LEO is an orbit with an altitude of 2,000 kilometers or less. The orbit of satellite devices 10 is affected by variations in atmosphere 17 of celestial object 15. Atmosphere 17 may comprise one or more layers of gases surrounding celestial object 15. For example, one of the layers of atmosphere 17 may be an ionosphere-thermosphere (IT), which is an upper atmosphere of the Earth. The mass density of the IT readily undergoes variations (referred to herein as “thermosphere mass density”) caused by space weather events (SWEs), such as irradiance of a Sun, solar rotation and cycle, diurnal and higher-order harmonics, magnetic storms and substorms, gravity waves, winds and tides, long-term climate change, and other factors. Additional examples of the variations of the IT are described Forbes, J., “Dynamics of the thermosphere,” Journal of the Meteorological Society of Japan, 85B, 2017, pp. 193-2013, accessed from https://doi.org/10.2151/jmsj.85B.193; and Emmert, J. “Thermospheric mass density: A review,” Advances in Space Research, 56(5), 2015, pp. 773-824, accessed from https://doi.org/10.1016/j.asr.2015.05.038, the entire contents of both of which are incorporated by reference herein.

The IT is a highly dynamic environment that readily undergoes variations that can be significant under certain conditions. Accurate modeling and prediction of the IT variations, caused by SWEs, are crucial for safeguarding the space assets, e.g., satellite devices 10, that serve various communities. Ionospheric enhancements caused by SWEs can hinder telecommunications while also affecting systems on-board the assets directly through surface charging and other phenomenon. Thermospheric mass density enhancements caused by SWEs have a direct and strong impact on the drag force acting on the space assets and other objects in LEO.

As the number of satellite devices 10 injected into the LEO is increased, owners and/or operators of the satellite devices 10 must predict the orbit of the satellite devices 10 to avoid collision. Collision of satellite devices 10 may render significant damage to the systems on board the satellite devices 10. Moreover, each collision event may push the space environment closer to a cascade, otherwise known as the Kessler syndrome, that can render space itself inaccessible for future generations.

To mitigate the threat of collision, owners and/or operators of the satellite devices 10 may use models to predict or forecast the orbit of the satellite devices in the context of Space Situational Awareness (SSA) and Space Traffic Management (STM). Typically, these models may include physics-based models and empirical models.

Physics-based models are based on physics principles and solve the fluid equations by discretizing over the volume of interest resulting in hundreds of thousands of solved for states. For example, physics based principles for objects orbiting celestial object 15 may include continuum mechanics, magnetospheric mechanics, etc. Although physics-based models provide good predictive and/or forecasting capabilities, physics-based models require dedicated parallel resources for real-time evaluation and data assimilative capabilities (i.e., the process of fusing observational data into numerical models to reduce uncertainty in the model forecast) that are insufficient. For example, traditional data assimilation methods solve the discretized fluid equations over a volumetric grid, which results in the full state being large in size (e.g., over a million estimated parameters). These data assimilation methods are computationally expensive since they require dedicated parallel resources for real-time application and the estimation may result in physically unrealistic values.

Empirical models specify the average behavior of the atmosphere 17 (e.g., thermosphere) with parameterized functions formulated using measurements or observations from multiple sources. Empirical models adopt a climatological approach to model the variations of the atmosphere 17. Empirical models capture the behavior of the atmosphere 17 in an average sense using low-order, parameterized mathematical formulations tuned to observation (i.e., simplified mathematical formulation). As one example, empirical models may determine the average behavior of the atmosphere 17 based on mapping a polynomial to measured climate data. Although empirical models are fast to evaluate (e.g., due to the simplified mathematical formulation), empirical models provide limited forecasting abilities because they do not model the system dynamically and are therefore less accurate.

In accordance with the techniques described herein, a transformative framework is provided for forecasting the state of atmosphere 17 for predicting the orbit of the satellite devices 10. As one example, transformative framework may include (i) the development of a quasi-physical dynamic reduced-order model (ROM) that uses a linear approximation of the underlying dynamics (e.g., solar conditions or magnetic conditions) and effect of the drivers, and (ii) data assimilation and calibration of the ROM through estimation of the ROM coefficients that represent the model parameters.

The quasi-physical dynamic ROM facilitates large data set evaluations for improved characterization of model uncertainty and collision probabilities at a significantly reduced cost. As one example, the quasi-physical dynamic ROM provides a linearized representation of a physics-based model of atmosphere 17. The physics-based model may be a simulation having a large data set of snapshots of the thermosphere mass density of atmosphere 17. The simulated data of the thermosphere mass density of atmosphere 17 may be a collection of the model/simulation output or experimental data acquired over time. For example, the simulated data may be generated based on initial inputs, such as solar conditions or magnetic conditions. The simulation may, for example, be generated for any duration of time, such as a full solar cycle (e.g., 12 years). In some examples, the quasi-physical dynamic ROM uses simulations from a Thermosphere-Ionosphere-Electrodynamics General Circulation Model (TIE-GCM).

Unlike traditional ROM techniques, such as Proper Orthogonal Decomposition (POD) (otherwise known as Empirical Orthogonal Functions (EOFs)), the quasi-physical dynamic ROM described herein provides predictive capabilities. For example, the quasi-physical dynamic ROM carries the same motivation and goals as POD, but uses a dynamic systems formulation that inherently facilitates future state prediction.

The quasi-physical dynamic ROM may use a dynamic mode decomposition with control (DMDc) extended for Hermitian space (HS) (otherwise referred to herein as “Hermitian Space-Dynamic Mode Decomposition with control (HS-DMDc)”) to extend the ROM to the upper atmosphere, e.g., ionosphere-thermosphere. The HS-DMDc is an extension of Dynamic Mode Decomposition (DMD) to dynamical systems with exogenous inputs. The HS-DMDc is derived from the equation-free DMDc algorithm (described in Proctor et al., “Dynamic mode decomposition with control,” SIAM Journal on Applied Dynamical Systems, 15(1), 2016, the entire contents of which is incorporated by reference herein), that also builds on DMD but can extract both the underlying dynamics and the input-output characteristics of a dynamical system. The HS-DMDc can be used to construct a ROM of the high-dimensional system for future state prediction under the influence of dynamics and external control. Unlike DMD, the snapshots (e.g., a collection of model/simulation output or experimental data acquired over time) include the state and input(s). The method characterizes the relationship between the future state, xₖ₊₁, the current state, xₖ, and the current input, uₖ, with a locally linearized model

xₖ₊₁=Axₖ+Buₖ,

where x∈ [symbol] ⁿ, u∈ [symbol] ^{p}, A∈ [symbol] ^{n×n}, and B∈∈ [symbol] ^{n×q}. The dynamic matrix A describes the unforced dynamics of the system and the input matrix B characterizes the effect of input uₖ on the state xₖ₊₁.

The difference between the HS-DMDc and DMDc algorithms is the formalism used in the computation of the pseudoinverse and the left singular vectors. In order for the derived model to be applicable for all space weather conditions, the simulated snapshots (xₖ) may represent a full range of inputs. Because a solar cycle lasts over a decade, this may require a large data set of more than (m≈) 400,000 snapshots with a 0.25-hr resolution. A 5° grid resolution in TIE-GCM results in a state vector size of (n 75,000 with a 2.5° grid resolution resulting in n≈300,000.

Large data have motivated extensions to DMD even beyond economy singular value decomposition (E-SVD) but have been limited to systems with no exogenous inputs. The computational complexity of full rank singular value decomposition (SVD) of X₁∈∈ [symbol] ^{n×m} used in DMDc is O(mn²) with n≤m, making its application intractable. The use of E-SVD reduces the complexity to O(mnr) by computing only the first r singular values and vectors. HS-DMDc reduces the computation of the pseudoinverse (t) to the Hermitian space by performing an eigendecomposition of the correlation matrix, X₁X_{T}∈∈ [symbol] ^{n×n}, reducing the full rank complexity to O(nn²). The complexity can be reduced to O(n²r) using an economy Eigendecomposition (E-ED). The computation of the correlation matrix X₁X₁^{T} also introduces linear scaling with m−O(mn²). It is important to note that using Eigendecomposition to compute the singular values and vectors can be more sensitive to numerical roundoff errors.

HS-DMDc uses the same time-shifted snapshot matrices as defined for DMD;

X₁=[x₁,x₂, . . . ,xₘ₋₁], X₂=[x₂,x₃, . . . ,xₘ],

however, the system now includes external control defined as Y=[u₁, u₂, . . . , uₘ₋₁].

$${X}_{1} = [ \begin{matrix}\vert & \vert & & \vert \\ {x}_{1} & {x}_{2} & … & {x}_{m - 1} \\ \vert & \vert & & \vert\end{matrix} ] {X}_{2} = [ \begin{matrix}\vert & \vert & & \vert \\ {x}_{2} & {x}_{3} & … & {x}_{m} \\ \vert & \vert & & \vert\end{matrix} ]$$

$$ϒ = [ \begin{matrix}\vert & \vert & & \vert \\ {u}_{1} & {u}_{2} & … & {u}_{m - 1} \\ \vert & \vert & & \vert\end{matrix} ]$$

HS-DMDc uses snapshot matrices (shown above) that are a collection of the time-resolved output from a physical system (e.g., TIE-GCM simulation output) to estimate the dynamic and input matrices (e.g., best fit estimate for A and B discussed below). The three-dimensional grid outputs over time are unfolded into column vectors and stacked together. The input matrix is an assimilation of the inputs to the system. In this case, the inputs used are the solar activity proxy, geomagnetic proxy, universal time and day of the year. In this example, the inputs may be derived using, for example, a TIE-GCM simulation output, such as 12 years of TIE-GCM simulations spanning a full solar cycle. The data matrices X1 and X2 can be related (X2 is the time evolution of X2) through a best fit linear model such that

x₂=AX₁.

The inclusion of the external control Y modifies the best fit linear model such that

X₂=AX₁+BY

To estimate A and B, the above equation is modified such that

X₂=ZΨ

where Z and Ψ are the augmented operator and data matrices, respectively.

$$Z {=}^{Δ} [ A B ] and Ψ {=}^{Δ} [ \begin{matrix}{X}_{1} \\ ϒ\end{matrix} ]$$

The estimate for Z, and hence A and B, is achieved with a Moore-Penrose pseudoinverse of Ψ such that Z=X₂Ψ^{†}. The goal is to estimate the dynamic and input matrices while minimizing ∥X₂−ZΨ∥. The augmented operator matrix is solved for just as in DMD, Z=X₂Ψ^{†}; however, the pseudoinverse of Ψ is computed in the Hermitian space using E-ED such that Ψ^{†}=Ω^{T}(ΨΨ^{T})⁻¹ and (ΨΨ^{T})⁻¹=(Û_{\hat{r}}ΞÛ_{\hat{r}}^{†})⁻¹=Û_{\hat{r}}Ξ\hat{r}⁻¹Û_{\hat{r}}^{†}. The orthogonal basis vectors Û_{\hat{r}}∈ [symbol] ^{(n+p)×\hat{r}}, equivalent to the left singular vectors of a SVD of Ψ, are eigenvectors of the correlation matrix ΨΨ^{T} (such that ΨΨÛ_{\hat{r}}=Û_{\hat{r}}Ξ_{\hat{r}}), where p is the number of inputs and r is the low rank truncation value for E-ED of Ψ.

The dynamic and input matrices can then be estimated as

A=X₂ΨÛ_{\hat{r}}\hat{Ξ}_{\hat{r}}⁻¹Û_{\hat{r},1}^{T} and B=X₂ΨÛ_{\hat{r}}\hat{Ξ}_{\hat{r}}⁻¹Û_{\hat{r},1}^{T},

where Ξ_{\hat{r}}∈ [symbol] ^{\hat{r}×\hat{r}} are the eigenvalues and Û_{\hat{r}}^{T}=[Û_{\hat{r}1}^{T}Û_{\hat{r}2}^{T}] with Û_{\hat{r}1}∈ [symbol] ^{n×\hat{r}} and Û_{\hat{r}2}∈ [symbol] ^{p×\hat{r}}. Again, the reduced order or low rank approximations for the dynamic and input matrices are achieved through projection onto a truncated POD basis. This, however, requires an additional E-ED in the Hermitian space for either X₁ or X₁ since Û_{\hat{r}} is defined in the input space and projection is performed in the output space. Substituting zₖ=Û_{\hat{r}}^{†}xₖ=Û_{\hat{r}}^{T} into the locally linearized model (xₖ₊₁=Axₖ+Buₖ) described above, becomes

Uᵣzₖ₊₁=AUᵣzₖ+Buₖ,

where Ûᵣ∈ [symbol] ^{n×r} are the orthogonal eigenvectors such that X₁X₁^{T}Uᵣ=UᵣΞᵣ, and r is the low rank truncation value such that r̅>r. Multiplying both sides by Uᵣ^{†} becomes

zₖ₊₁=Uᵣ^{†}AUᵣzₖ+Uᵣ^{†}Buₖ=Ãzₖ+\tilde{B}uₖ.

The reduced order state vector again represents the coefficients of the POD modes. The reduced order approximations for the dynamic and input matrices are then computed as

Ã=Uᵣ^{T}AUᵣ=Uᵣ^{T}X₂ΨÛ_{\hat{r}}\hat{Ξ}_{\hat{r}}⁻¹Û_{\hat{r},1}^{T}Uᵣ and \tilde{B}=Uᵣ^{T}B=Uᵣ^{T}X₂ΨÛ_{\hat{r}}\hat{Ξ}_{\hat{r}}⁻¹Û_{\hat{r},2}^{T},

where Ξᵣ [symbol] ^{r×r} are the eigenvalues.

Because the state size, n, can also be very large making computation and storage of the dynamic and input matrices intractable, a reduced state is used to model the evolution of the dynamical system.

zₖ₊₁=Aᵣzₖ+Bᵣuₖ+wₖ

where Aᵣ∈ [symbol] ^{r×r} the reduced dynamic matrix and Bᵣ∈ [symbol] ^{r×p} is the reduced input matrix in discrete time, z∈ [symbol] ^{r×1} the reduced state, and wₖ is the process noise that accounts for the unmodeled effects and the ROM truncation error. The state reduction is achieved using a similarity transform zₖ=Uᵣ^{†}xₖ=Uᵣ^{T}xₖ, where Uᵣ are the first r POD modes. As further described below, the data assimilation process will estimate the reduced state, z, that represents the coefficients of the POD modes and can be thought of as model parameters that relate the model input(s) to the output(s). It can also provide insights into the model dynamics.

The steps involved in HS-DMDc are summarized below.

Algorithm 1 Hermitian Space-Dynamic Mode Decomposition With control

1. Construct the data matrices X₁, X₂, Y, and Ψ.
2. Compute the pseudoinverse of Ψ using an economy eigendecomposition (E-ED) in the Hermitian Space.
The choice of \hat{r} depends on several factors.

| | |
|---|---|
| ΨΨ^{T} = [symbol] | (9) |
| ⇒ Ψ^{t} = Ψ^{T} (ΨΨ^{T})⁻¹ = Ψ^{T}( [symbol] )⁻¹ = Ψ^{T} [symbol] | (10) |

3. Perform a second E-ED in the Hermitian space to derive the POD modes (Uᵣ) for reduced-order projection.
Choose the truncation value r such that \hat{r} > r.

| | |
|---|---|
| X₁X₁^{T} = [symbol] | (11) |

4. Compute the reduced-order dynamic and input matrices

| Ã = Uᵣ^{T}X₂Ψ [symbol] Uᵣ | | (12) |
|---|---|---|
| | \tilde{B} = Uᵣ^{T}X₂Ψ [symbol] | (13) |

where [symbol] = [ [symbol] ] with [symbol] ϵ [symbol] and [symbol] ϵ

[symbol]

The second part of the transformative framework provides calibration of the quasi-physical dynamic ROM through data assimilation. Data assimilation is the process of fusing observational data (i.e., measurement data) into numerical models to reduce uncertainty in the model forecast. In some examples, the transformative framework uses a sequential filter (e.g., Kalman filter) for data assimilation. As further described below, the quasi-physical dynamic ROM is calibrated by applying the Kalman filter to measurements of the satellite devices 10 and the quasi-physical dynamic ROM to estimate the quasi-physical dynamic ROM coefficients that represent the model parameters.

Satellite devices 10 may include one or more measurement devices, such as accelerometers, gyroscopes, magnetometers, ground-based radar and optical sensors, on-board GPS devices, or other measurement devices, to collect orbital elements of one or more satellite devices 10 orbiting around a celestial object 15. Orbital elements are parameters that uniquely identify a specific orbit. For example, orbital elements may be numbers that describe the orbit of a satellite device. Orbital elements may be defined by mean distance, inclination, eccentricity, longitude of the ascending node, argument of Perihelion, mean anomaly, and true anomaly. In this example, each of the satellite devices 10 may include one or more accelerometers to measure acceleration of the device, from which the thermospheric mass density may be derived. In other examples, the computing platform that implements the transformative framework may receive measurements from other satellite devices or radar devices performing the measurements, such as CHAllenging Minisatellite Payload (CHAMP) satellite and/or Gravity Recovery and Climate Experiment (GRACE) satellite.

The Kalman filter is used for state estimation and prediction using discrete time linear systems. The Kalman filter requires propagating the state to the next measurement time, which most likely will not be uniformly distributed and/or with a snapshot resolution used to derive the dynamic and input matrices for the quasi-physical dynamic ROM. Therefore, the dynamic and input matrices for the quasi-physical dynamic ROM may need to be converted between discrete and continuous time, essential for assimilating data using a Kalman filter in the transformative framework. This can be achieved using the following relation as described in DeCarlo, “Linear systems: A state variable approach with numerical implementation, Upper Saddle River, N.J., USA: Prentice-Hall, Inc., 1989, the contents of which is incorporated by reference herein:

$$[ \begin{matrix}{A}_{c} & {B}_{c} \\ 0 & 0\end{matrix} ] = log ( [ \begin{matrix}{A}_{d} & {B}_{d} \\ 0 & I\end{matrix} ] ) / T$$

where [A_{c}, A_{d}] are the dynamic matrices and [B_{c}, B_{d}] are the input matrices in continuous and discrete time, respectively, and T is the sample time (snapshot resolution when converting from discrete to continuous time and the time to next measurement, tₖ, when converting back from continuous to discrete time). This represents another major advantage of the framework where the time step of model evolution can be readily adjusted.

The Kalman filter combines information from models and observations (e.g., measurements) by processing observations as they become available, and produces estimates of unknown variables. In this example, the output of the Kalman filter may be used to predict the orbit of satellite devices 10 based on the combination of information from the quasi-physical dynamic ROM and measurements (e.g., from the accelerometer or other measurement devices).

The Kalman filter has two major steps: (i) time update and (ii) measurement update, as outlined in the algorithm below. The time update projects the current state and covariance estimate forward through the model to the time of next measurement. The projected state (xₖ⁻) and covariance (Pₖ⁻), signified by the negative superscript, represent the a priori knowledge about the state of the system. The process noise (Q) in equation (17) below accounts for the imperfect model dynamics. The a priori covariance, the measurement variance (Rₖ), and the observation matrix (Hₖ) are combined to compute the Kalman Gain (Kₖ) as given in equation (18) below. A Monte Carlo estimate for Rₖ in the log scale is made based on the uncertainties associated with the measurements (ρ, mass density). For example, the Monte Carlo estimate is made by sampling the Gaussian 100 times and recomputing the variance using the samples such that Rₖ≈Var [log(ρk+Δρk*randn(100))]. The observation matrix Hₖ^{T}∈ [symbol] ^{r×1}, which relates the measurements (yₖ⁻) to the state (zₖ) by mapping it onto the measurement space, is in this case a vector made up of the interpolated values at the measurement location of the first r POD modes such that \tilde{y}ₖ=Hₖzₖ+vₖ, where vₖ is the measurement error. In simple terms, the Kalman Gain reflects the weights or confidence for the a priori estimate against the measurement. The Kalman Gain is then used to update the a priori state and covariance estimate as given in equations (19) and (20) below. The updated state (xₖ⁺) and covariance (Pₖ⁺), signified by the positive superscript, represent the posteriori knowledge about the state of the system achieved after data assimilation. The posteriori estimates are fed back into steps 1 and 2 until all the measurements have been processed. In the absence of measurements, the state and covariance are propagated through the model until a measurement is available. The steps involved in the Kalman filter are summarized below:

Algorithm 2 Kalman Filter

| Time Update | |
|---|---|
| 1. Project the initial state estimate forward in time | |
| xₖ₊₁⁻ = Axₖ + Buₖ | (16) |
| 2. Project the initial covariance estimate forward in time | |
| Pₖ₊₁⁻ = APₖA^{T} + Q | (17) |
| Measurement Update | |
| 3. Compute the Kalman Gain | |
| Kₖ₊₁ = Pₖ₊₁⁻Hₖ₊₁^{T} (Hₖ₊₁Pₖ₊₁⁻Hₖ₊₁^{T} + Rₖ₊₁)⁻¹ | (18) |
| 4. Update the state estimate | |
| xₖ₊₁⁺ = xₖ₊₁⁻ + kₖ₊₁ = (\tilde{y}ₖ₊₁ − Hₖ₊₁xₖ₊₁⁻) | (19) |
| 5. Update the covariance estimate | |
| Pₖ₊₁⁺ = (I − Kₖ₊₁Hₖ₊₁) Pₖ₊₁⁻ | (20) |

In some instances, there is a lack of knowledge on the process noise statistics when applying the Kalman filter. In some examples, a Bayesian Optimization (BO) approach is used to optimize the filter. The BO may use a process noise model to account for unmodeled effects that are not captured by TIE-GCM and errors induced in the model reduction process. Tuning the Kalman filter includes estimating statistics for process and measurement noise. Assuming that the measurement noise values reported for the data set used are accurate, only the process noise covariance is tuned. In addition, the initial covariance (P₀) is tuned as it is usually difficult to produce a good estimate for the initial covariance.

Bayesian Optimization (BO) is a method for blackbox optimization of stochastic cost function. BO is used because the cost is a complex function of the process noise (Q) and stochastic due to the measurement noise (R). The cost function is used for maximum likelihood estimation given as

$${min}_{q} ∠ ( \tilde{y} \vert q ) = {\sum }_{k = 1}^{N} log ( det ( {R}_{k} + {H}_{k} {P}_{k}^{+} {H}_{k}^{T} ) ) + {( {\hat{y}}_{k} - {\tilde{y}}_{k} )}^{T} {( {R}_{k} + {H}_{k} {P}_{k}^{+} {H}_{k}^{T} )}^{- 1} ( {\hat{y}}_{k} - {\tilde{y}}_{k} )$$

where ŷₖ is the estimated density and Q=diag(q), q∈ [symbol] ^{r×1}. The range of optimizable process noise Q is set at [1e-6, 1e-1]. Because the reduced state that represents the POD coefficients is estimated, the range of optimizable initial covariance P₀ is set at [1e1,1e2]. The number of iterations is set at the default of 30. The optimized process noise matrix Q₀ and initial covariance matrix P0 are then used to initialize the Kalman filter.

The techniques may provide one or more technical advantages. For example, the quasi-physical dynamic ROM reduces the cost of model evaluation to the level of empirical models while inherently providing forecast/predictive capabilities. Unlike large-scale physical models, the quasi-physical dynamic ROM formulation allows rapid modifications in the time step of model evaluation or simulation with a negligible increase in the computational cost. This allows the model to be easily projected to the time of next measurement. The quasi-physical dynamic ROM formulation also allows large ensemble runs of the models for improved characterization and quantification of forecast uncertainty, a crucial requirement for accurate computation of collision probabilities.

Moreover, because the data assimilation (e.g., via application of a Kalman filter) of the transformative framework may estimate a reduced state that represents model parameters, the data assimilation may dynamically bring the model to agreement with measurements without modifying the model dynamics. Further, by estimating model parameters rather than the input(s)/driver(s), the model is able to be calibrated to prevent degradation of model performance in the absence of measurement data.

The transformative framework requires minimal computational resources. That is, by using the transformative framework, the satellite orbit is accurately computed while using less fuel consumption and reducing costs. Moreover, the transformative framework can be readily incorporated into operations, and can be incorporated into the satellite devices or remotely within a ground-based control station that controls the satellite devices.

FIG. 2 shows a detailed example of a computing environment, such as within a satellite device or a ground-based system, that may be configured to implement the techniques described in this disclosure. For example, computer 500 may represent a processor or execution environment within each of satellite devices 10 of FIG. 1, capable of executing the techniques described herein.

In this example, a computer 500 includes a hardware-based processor 510 that may be incorporated into satellite device 10 to execute program instructions or software, causing the computer to perform various methods or tasks, such as performing the techniques of the transformative framework described herein. Although illustrated as incorporated into satellite device 10, computer 500 may be implemented in any device or system, e.g., a ground-based control station, that controls and/or manages satellite devices 10.

Processor 510 may be a general-purpose processor, a digital signal processor (DSP), a core processor within an Application Specific Integrated Circuit (ASIC) and the like. Processor 510 is coupled via bus 520 to a memory 530, which is used to store information such as program instructions and other data while the computer is in operation. A storage device 540, such as a hard disk drive, nonvolatile memory, or other non-transient storage device stores information such as program instructions, data files of the multidimensional data and the reduced data set, and other information. As another example, computer 500 may provide an operating environment for execution of one or more virtual machines that, in turn, provide an execution environment for software for implementing the techniques described herein.

The computer also includes various input-output elements 550, including parallel or serial ports, USB, Firewire or IEEE 1394, Ethernet, and other such ports to connect the computer to external device such a printer, video camera, surveillance equipment or the like. Other input-output elements include wireless communication interfaces such as Bluetooth, Wi-Fi, and cellular data networks. The computer itself may be any type of computerized system with actuators. The computer in a further example may include fewer than all elements listed above.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

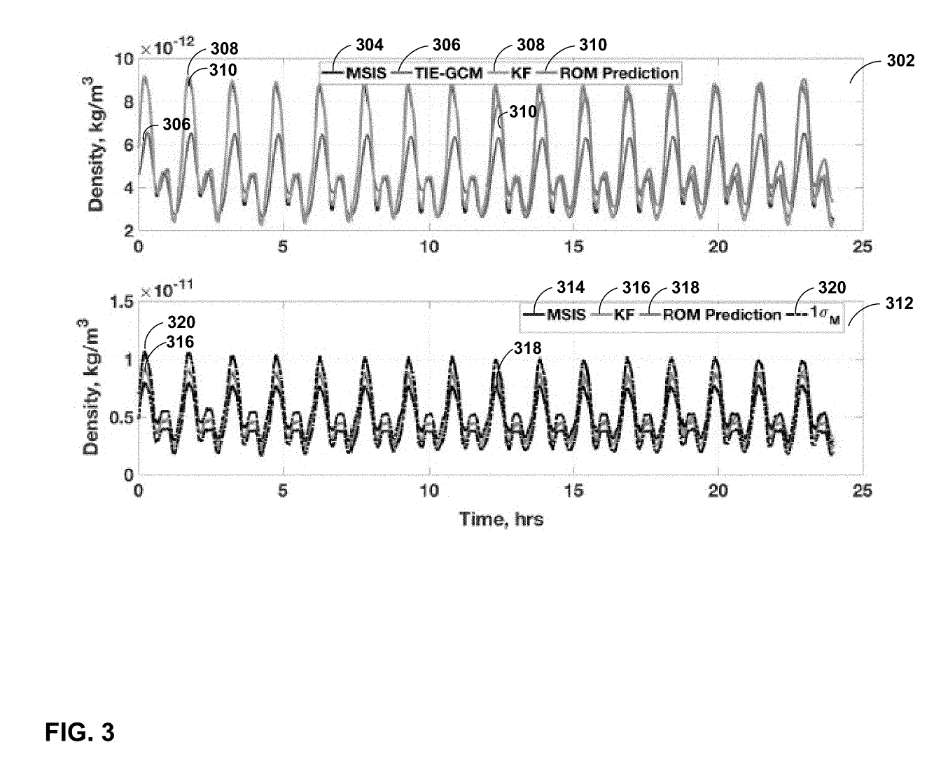

FIG. 3 illustrates an example of the effectiveness of the data assimilation process through the transformative framework, in accordance with the techniques described herein. In the example of FIG. 3, the top graph 302 includes simulated output from Naval Research Laboratory's Mass Spectrometer and Incoherent Scatter (MSIS) model 304 (“MSIS 304”) along a satellite orbit (e.g., CHAMP orbit), TIE-GCM densities 306 (“TIE-GCM 306”) along the satellite orbit, Kalman filter assimilated ROM density 308 (“KF 308”). The top graph 302 also includes ROM-predicted densities with Kalman filter estimated uncertainties 310 (“ROM Prediction 310”) along the satellite orbit that evolves under the dynamics captured by the quasi-physical dynamic ROM.

The bottom graph 312 illustrates the simulated MSIS measurements 314, the estimated Kalman filter assimilated ROM density 316, ROM-predicted densities with Kalman filter estimated uncertainties 318 (“ROM Prediction 318”) with 1σ covariance bounds 320 estimated as part of the data assimilation. The uncertainty bounds are computed by projecting the state covariance of the equation for updating the covariance estimate (Pₖ₊₁⁺=(1−Kₖ₊₁Hₖ₊₁)Pₖ₊₁⁻) onto the measurement space

$${P}_{k}^{yy} = {( {H}_{k} {P}_{k} {H}_{k}^{T} + {R}_{k} )}^{0.5} \qquad ( 22 )$$

As illustrated in the bottom graph 312 of FIG. 3, the measured (simulated) and predicted densities lie within the estimated 1σ uncertainty bounds. The full day pre-assimilation root-mean-square (rms) difference between TIE-GCM and MSIS (simulated measurements) densities along the satellite orbit is 1.269e-12 kg/m³, while post-assimilation the rms difference is 1.139e-13 kg/m³.

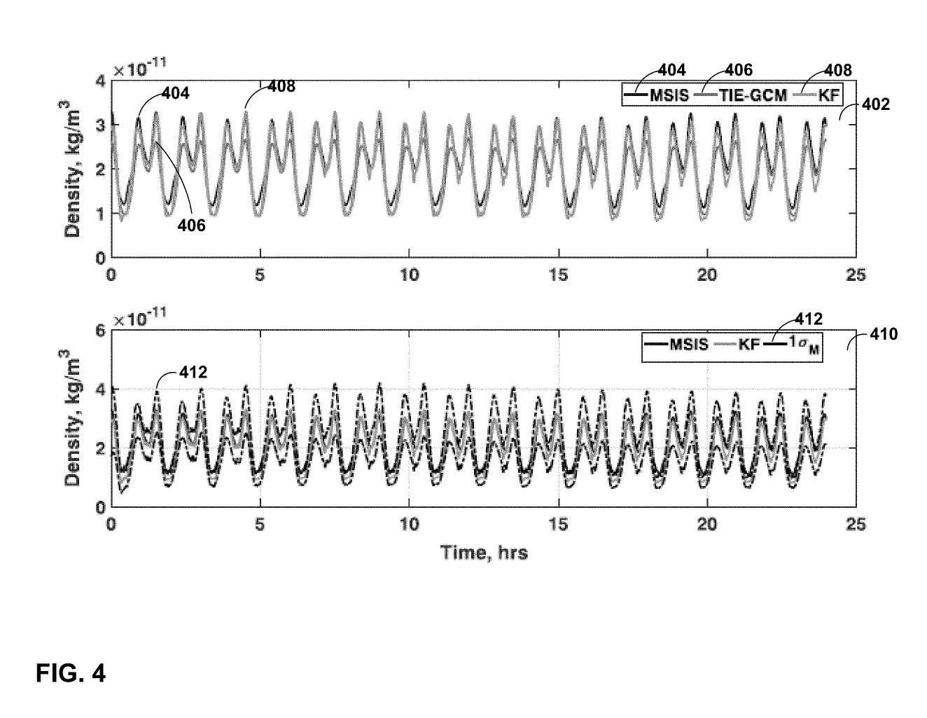

FIG. 4 illustrates an example of the validation of the assimilation process using an independent set of simulated measurements (MSIS) along the satellite orbit (e.g., GOCE orbit), in accordance with the techniques described herein. The top graph 402 includes validation of the data assimilation process using MSIS simulated independent measurements 404 (“MSIS 404”) along a satellite orbit (e.g., GOCE orbit), TIE-GCM densities 406 (“TIE-GCM 406”) along the satellite orbit, Kalman filter assimilated ROM density 408 (“KF 408”). The validation confirms that the reduced state, which provides global calibration, can be estimated using discrete measurements along a single orbit. The quasi-physical dynamic ROM is tuned with simulated MSIS density along the CHAMP orbit, with the corrected state accurately predicting the simulated MSIS density along GOCE orbit. Results show that the approach can self-consistently calibrate the model while preserving the underlying dynamics. The bottom graph 410 shows that the simulated GOCE measurements lie within the estimated 1σ bounds 412. The pre-assimilation rms difference between TIE-GCM and MSIS (simulated measurements) densities along GOCE orbit is 3.078e-12 kg/m³, while post-assimilation the rms difference is 2.137e-12 kg/m³.

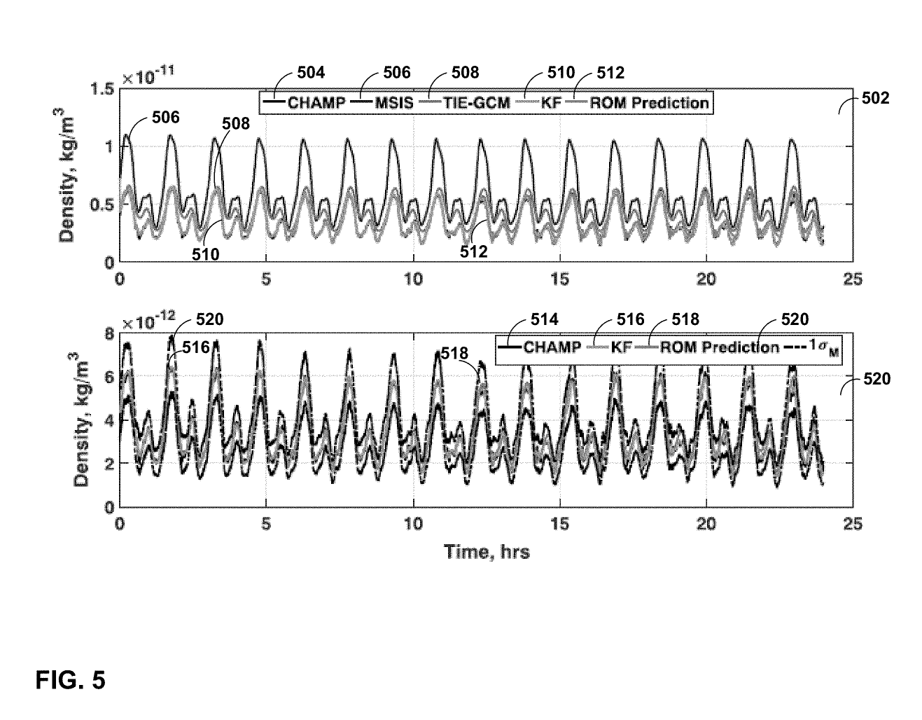

FIG. 5 illustrates an example of assimilation results for the filter initialized with MSIS, in accordance with the techniques described herein. The top graph 502 includes satellite (e.g., CHAMP) measurements 504, MSIS 506, TIE-GCM 508, and the assimilated densities 510. The additional prediction ensemble 512 is also shown. Just as in the simulated case (e.g., FIG. 3), the transformative framework tracks the measurements and may provide accurate forecasts. In this case, the approach corrects for the both day-night magnitude difference and for the absolute scale biases, which represents the major component of the errors due to drag. The bottom graph 520 includes the satellite measurements 514, and the estimated density 516 and the predicted density 518 with 1σ covariance bounds 520 estimated as part of the data assimilation. The uncertainty bounds are again computed by projecting the state covariance onto the measurement space. As seen, the measurements 514, and the estimated 516 and predicted 516 densities lie within the estimated 1σ uncertainties bounds 520. The pre-assimilation and post-assimilation rms difference values are given in Table 1.

TABLE 1
RMS Difference for Real Measurements
Case in Kilograms per Cubic Meters

Model

Assimilated

| | | | MSIS | TIE-GCM |
|---|---|---|---|---|
| Satellite | MSIS | TIE-GCM | initialized | initialized |
| CHAMP | 2.91e−12 | 1.34e−13 | 1.34e−13 | 1.30e−13 |
| GOCE | 7.24e−12 | 2.18e−12 | 2.18e−12 | 2.05e−12 |

Note.
RMS = Root-Mean-Square;
MSIS = Mass Spectrometer and Incoherent Scatter;
TIE-GCM = Thermosphere-Ionosphere-Electrodynamics General Circulation Model;
CHAMP = CHAllenging Minisatellite Payload.
GOCE = Gravity Field and Steady-State Ocean Circulation Explorer

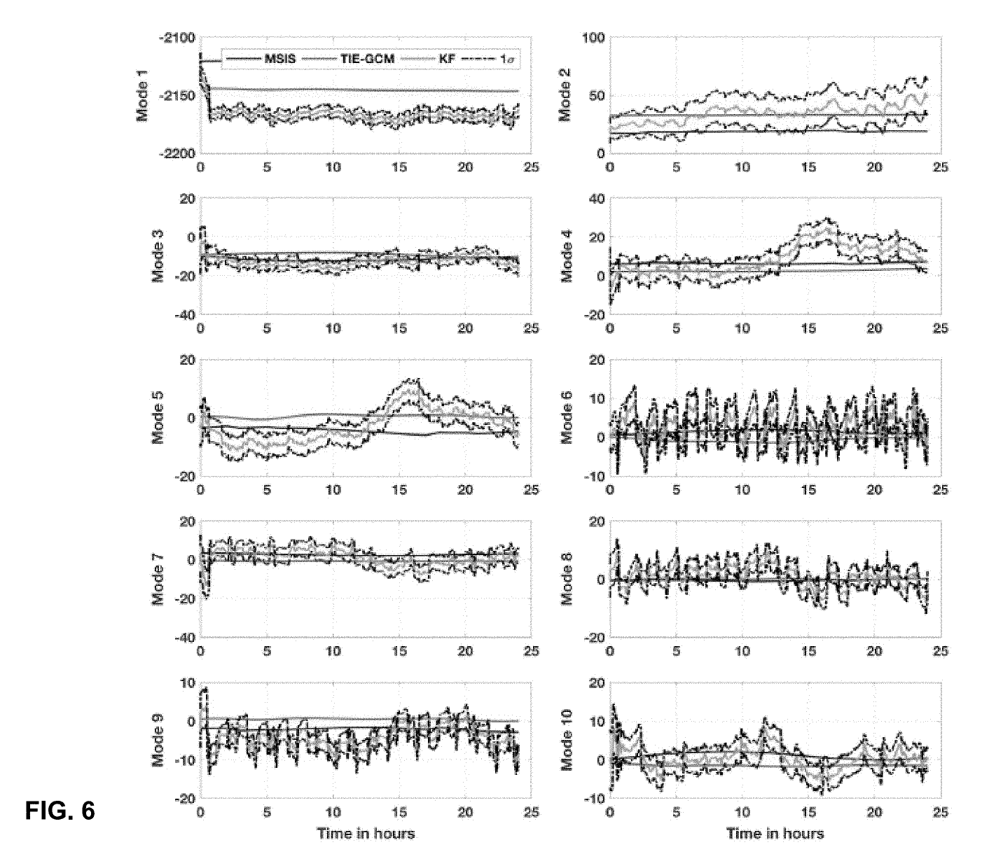

FIG. 6 illustrates an example of the estimated reduced-order state and uncertainty with data assimilation, in accordance with the techniques described herein. As previously discussed, the reduced state represents the POD coefficients for the first r modes used for order reduction. In the example of FIG. 6, the POD coefficients are shown for MSIS and TIE-GCM obtained by projecting the simulation output for the day onto the POD modes. The first two modes correspond to absolute scale correction (scaling with solar activity), while others represent variations on the different timescales.

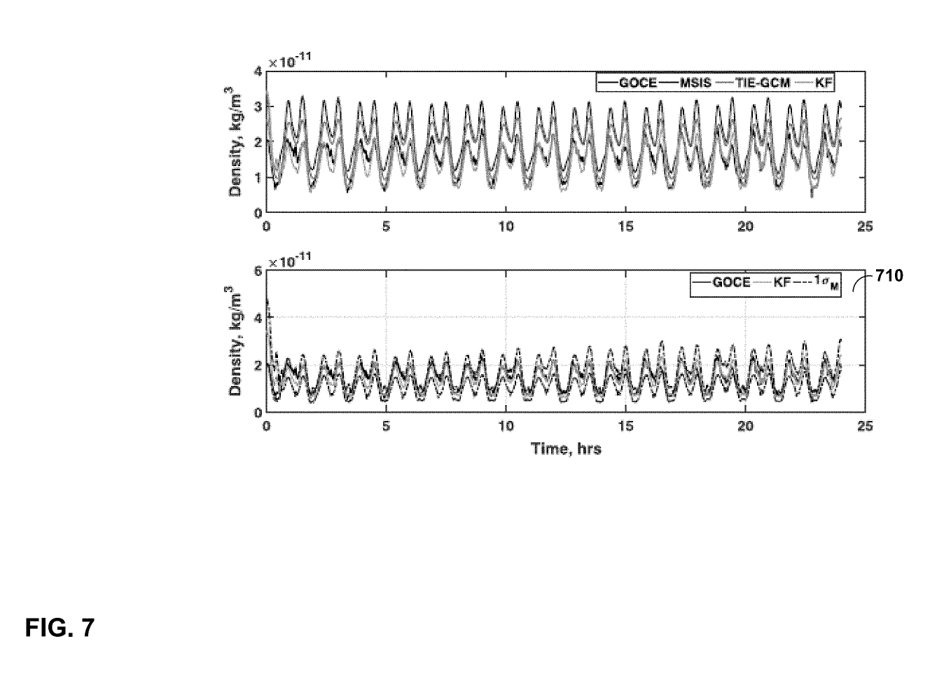

FIG. 7 illustrates an example of the validation of the data assimilation using an independent data set of satellite (e.g., GOCE) accelerometer-derived mass density, in accordance with the techniques described herein. The validation again confirms that the reduced state, which provides global calibration, can be estimated using discrete measurements along a single orbit. The quasi-physical dynamic ROM is tuned with CHAMP densities, with the corrected state accurately predicting the density along GOCE orbit. Results show that the approach can self-consistently calibrate the model while preserving the underlying dynamics. The bottom graph 710 shows that the GOCE measurements 712 lie within the estimated 1σ bounds 716 about the estimated density 714. The pre-assimilation and post-assimilation rms difference values are again provided in Table 1 shown above.

Table 1 also shows the rms difference values for the real measurements case with initialization using TIE-GCM. The results, as anticipated, are very similar with TIE-GCM initialization slightly outperforming the initialization with MSIS. If the user prefers to initialize with TIE-GCM, a POD representation of the TIE-GCM simulation output using some form of regression can be used.

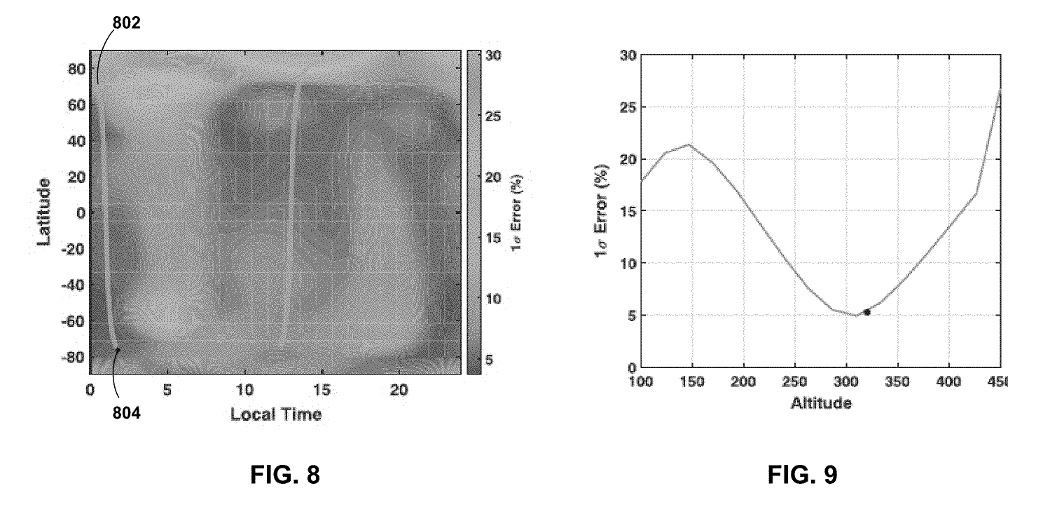

FIGS. 8 and 9 illustrate examples of the global estimated covariance as a projection away from the location of measurements, in accordance with the techniques described herein. The curve 802 in FIG. 8 represents a satellite (e.g., CHAMP) orbit path with the point 804 corresponding to the current location. The global uncertainty estimate is generated after all the data have been assimilated. The global field is generated using Pₖ^{yy}=(HₖPₖHₖ^{T}+Rₖ)^{0.5} as shown above, but without the measurement error R and with H computed over the grid at the mean altitude of CHAMP. As seen, the uncertainty is reduced in the vicinity of the satellite path where the measurements are assimilated. The uncertainty is the largest at the pole because of the singularity constraint. The ROM captures the singularity constraint at the pole; however, assimilating inconsistent (densities derived using different methods) data can cause this constraint to not be satisfied, resulting in larger uncertainties close to the poles. FIG. 9 illustrates an example of the error that is at a minimum at the altitude of CHAMP but increases moving away from the assimilated path. Even though ingesting data along an orbit path can provide global estimates using the transformative framework, the global errors, including close to the poles, can be further reduced with improved spatial and temporal coverage of measurements.

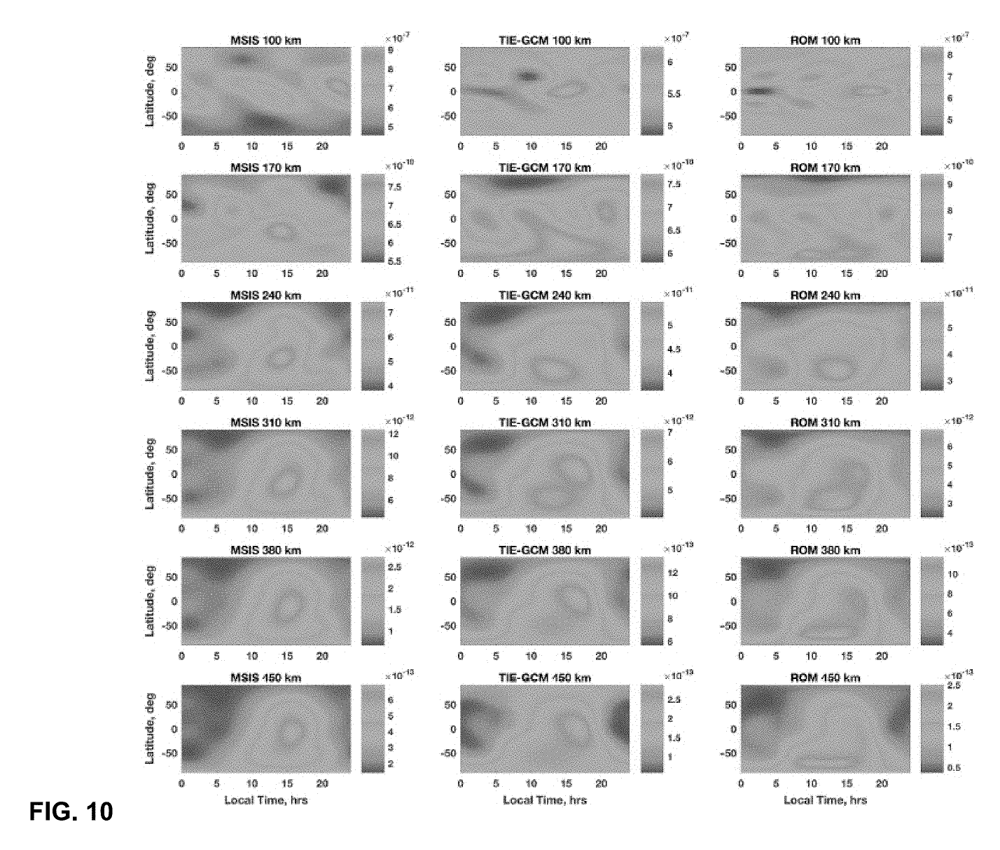

FIG. 10 shows the comparison of MSIS and TIE-GCM profiles against the ROM assimilated profiles at a series of altitudes, in accordance with the techniques described herein. As seen, except for the profile at 100 km, the MSIS and assimilated ROM profiles show similar distributions. The difference at 100 km is due to the lower boundary effects. TIE-GCM and ROM have similar profiles at the lower boundary as expected. The absolute scale of the assimilated densities suggests that MSIS overpredicts the mass density across (almost) all altitudes during periods of low solar activity. As can be seen, the transformative framework effectively calibrates existing physical models by adjusting the absolute scale, which is a major driver of orbit prediction errors. Results also show that TIE-GCM slightly underpredicts mass density below about 250 km (GOCE altitude) on the day while overpredicting at higher altitudes.

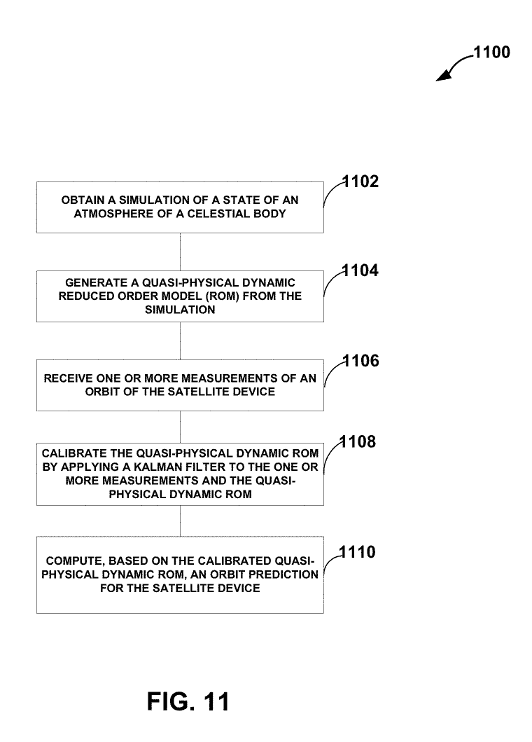

FIG. 11 illustrates a flowchart of an example operation 1100 of a computing device providing a transformative framework, in accordance with the techniques described in this disclosure. For ease of illustration, FIG. 11 is described with respect to environment 2 of FIG. 1.

In the example of FIG. 11, the computing device may obtain a simulation of a state of an atmosphere of a celestial body, wherein a satellite device is orbiting the celestial body (1102). For example, the computing device may be located within one or more of satellite devices 10 or positioned remotely, such as within a ground-based control station that controls the satellite devices 10. The simulation of a physics-based model may have a large data set of snapshots of the thermosphere mass density of atmosphere 17. The simulated data of the thermosphere mass density of atmosphere 17 may be a collection of the model/simulation output or experimental data acquired over time. For example, the simulated data may be generated based on initial inputs, such as solar conditions or magnetic conditions. The simulation may, for example, be generated for any duration of time, such as a full solar cycle (e.g., 12 years). In some examples, the quasi-physical dynamic ROM uses simulations from a Thermosphere-Ionosphere-Electrodynamics General Circulation Model (TIE-GCM).

The computing device may generate a quasi-physical dynamic Reduced Order Model (ROM) from the simulation, wherein the quasi-physical dynamic ROM is a model used to estimate a future state of the atmosphere (1104). For example, the quasi-physical dynamic ROM is constructed from a Dynamic Mode Decomposition with control (DMDc) algorithm that is extended for Hermitian Space. The quasi-phsyical dynamic ROM may include reduced-order dynamic and input matrices computed as:

Ã=Uᵣ^{T}AUᵣ=Uᵣ^{T}X₂ΨÛ_{\hat{r}}\hat{Ξ}_{\hat{r}}⁻¹Û_{\hat{r},1}^{T}Uᵣ and \tilde{B}=Uᵣ^{T}B=Uᵣ^{T}X₂ΨÛ_{\hat{r}}\hat{Ξ}_{\hat{r}}⁻¹Û_{\hat{r},2}^{T},

The computing device may receive one or more measurements of an orbit of the satellite device (1106). For example, the computing device may include one or more measurement devices, such as accelerometers, gyroscopes, magnetometers, ground-based radar and optical sensors, on-board GPS devices, or other measurement devices, to collect orbital elements of one or more satellite devices 10 orbiting around a celestial object 15. Orbital elements are parameters that uniquely identify a specific orbit. Orbital elements may be defined by mean distance, inclination, eccentricity, longitude of the ascending node, argument of Perihelion, mean anomaly, and true anomaly. In this example, each of the satellite devices 10 may include one or more accelerometers to measure acceleration of the device, from which the thermospheric mass density may be derived. In other examples, the computing platform that implements the transformative framework may receive measurements from other satellite devices or radar devices performing the measurements, such as CHAllenging Minisatellite Payload (CHAMP) satellite and/or Gravity Recovery and Climate Experiment (GRACE) satellite.

The computing device may calibrate the quasi-physical dynamic ROM by applying a Kalman filter to the one or more measurements and the quasi-physical dynamic ROM (1108). In some examples, the dynamic and input matrices of the quasi-physical dynamic ROM is first converted to a continuous time space before applying the Kalman filter. The Kalman filter is used to calibrate the quasi-physical dynamic ROM through data assimilation. The Kalman filter provides state estimation and prediction. That is, the Kalman filter is used to estimate a reduced state that represents the quasi-physical dynamic ROM parameters rather than the input(s)/driver(s).

The computing device may compute, based on the calibrated quasi-physical dynamic ROM, an orbit prediction for the satellite device (1110). For example, the computing device may compute, based on the calibrated quasi-physical ROM, orbital drag, collision conjunctions, and collision avoidance for the satellite device.

Various examples have been described. These and other examples are within the scope of the following claims.

What is claimed is:

1. A computing device comprising:
one or more processors, wherein the one or more processors are configured to:
obtain a simulation of a state of an atmosphere of a celestial body, wherein a satellite device is orbiting the celestial body;
generate a quasi-physical dynamic Reduced Order Model (ROM) from the simulation, wherein the quasi-physical dynamic ROM is a model used to estimate a future state of the atmosphere;
receive one or more measurements of an orbit of the satellite device;
calibrate the quasi-physical dynamic ROM by applying a Kalman filter to the one or more measurements and the quasi-physical dynamic ROM; and
compute, based on the calibrated quasi-physical dynamic ROM, an orbit prediction for the satellite device.

2. The computing device of claim 1, wherein the device is located within the satellite device.

3. The computing device of claim 1, wherein the device is located within a ground-based control station that controls the satellite device.

4. The computing device of claim 1, wherein, to obtain the simulation of the state of an atmosphere of the celestial body, the one or more processors are configured to obtain the simulation from a Thermosphere-Ionosphere-Electrodynamics General Circulation Model (TIE-GCM).

5. The computing device of claim 1, wherein the quasi-physical dynamic ROM includes reduced-order dynamic and input matrices computed as:
Ã=Uᵣ^{T}AUᵣ=Uᵣ^{T}X₂ΨÛ_{\hat{r}}\hat{Ξ}_{\hat{r}}⁻¹Û_{\hat{r},1}^{T}Uᵣ and \tilde{B}=Uᵣ^{T}B=Uᵣ^{T}X₂ΨÛ_{\hat{r}}\hat{Ξ}_{\hat{r}}⁻¹Û_{\hat{r},2}^{T},

6. The computing device of claim 1, wherein the state of the atmosphere comprises the state of thermospheric mass density of the celestial object.

7. The computing device of claim 1, wherein, to compute the orbit prediction for the satellite device, the one or more processors are configured to compute, based on the calibrated quasi-physical dynamic ROM, at least one of orbital drag, collision conjunctions, and collision avoidance for the satellite device.

8. The computing device of claim 1, wherein the quasi-physical dynamic ROM is constructed from a Dynamic Mode Decomposition with control (DMDc) algorithm that is extended for Hermitian Space.

9. The computing device of claim 1, wherein the one or more processors is further configured to:
convert dynamic and input matrices of the quasi-physical dynamic ROM to a continuous time space to apply the Kalman filter.

10. The computing device of claim 1, wherein, to receive one or more measurements of the orbit of the satellite device, the one or more processors are configured to receive one or more orbital elements defined by at least one of mean distance, inclination, eccentricity, longitude of the ascending node, argument of Perihelion, mean anomaly, and true anomaly.

11. A method comprising:
obtaining, by a computing device, a simulation of a state of an atmosphere of a celestial body, wherein a satellite device is orbiting the celestial body;
generating, by the computing device, a quasi-physical dynamic Reduced Order Model (ROM) from the simulation, wherein the quasi-physical dynamic ROM is a model used to estimate a future state of the atmosphere;
receiving, by the computing device, one or more measurements of an orbit of the satellite device;
calibrating, by the computing device, the quasi-physical dynamic ROM by applying a Kalman filter to the one or more measurements and the quasi-physical dynamic ROM; and
computing, by the computing device and based on the calibrated quasi-physical dynamic ROM, an orbit prediction for the satellite device.

12. The method of claim 11, wherein the computing device is located within the satellite device.

13. The method of claim 11, wherein the computing device is located within a ground-based control station that controls the satellite device.

14. The method of claim 11, wherein, to obtain the simulation of the state of an atmosphere of the celestial body, the one or more processors are configured to obtain the simulation from a Thermosphere-Ionosphere-Electrodynamics General Circulation Model (TIE-GCM).

15. The method of claim 11, wherein the quasi-physical dynamic ROM includes reduced-order dynamic and input matrices computed as:
Ã=Uᵣ^{T}AUᵣ=Uᵣ^{T}X₂ΨÛ_{\hat{r}}\hat{Ξ}_{\hat{r}}⁻¹Û_{\hat{r},1}^{T}Uᵣ and \tilde{B}=Uᵣ^{T}B=Uᵣ^{T}X₂ΨÛ_{\hat{r}}\hat{Ξ}_{\hat{r}}⁻¹Û_{\hat{r},2}^{T},

16. The method of claim 11, wherein the state of the atmosphere comprises the state of thermospheric mass density of the celestial object.

17. The method of claim 11, wherein the quasi-physical dynamic ROM is constructed from a Dynamic Mode Decomposition with control (DMDc) algorithm that is extended for Hermitian Space.

18. The method of claim 11, further comprising:
converting, by the computing device, dynamic and input matrices of the quasi-physical dynamic ROM to a continuous time space to apply the Kalman filter.

19. The method of claim 10, wherein receiving one or more measurements of the orbit of the satellite device comprises receiving one or more orbital elements defined by at least one of mean distance, inclination, eccentricity, longitude of the ascending node, argument of Perihelion, mean anomaly, and true anomaly.

20. A computer-readable data storage medium having instructions stored thereon that cause a computing system to:
obtain a simulation of a state of an atmosphere of a celestial body, wherein a satellite device is orbiting the celestial body;
generate a quasi-physical dynamic Reduced Order Model (ROM) from the simulation, wherein the quasi-physical dynamic ROM is a model used to estimate a future state of the atmosphere;
receive one or more measurements of an orbit of the satellite device;
calibrate the quasi-physical dynamic ROM by applying a Kalman filter to the one or more measurements and the quasi-physical dynamic ROM; and
compute, based on the calibrated quasi-physical dynamic ROM, an orbit prediction for the satellite device.
